(19) United States
(12) Patent Application Publication
(10) Pub. No.: US 2006/0078653 A1
(43) Pub. Date: Apr. 13, 2006

(54) Preservation structure and preservation repository using the same

(76) Inventors: Ching-Fuh Lin, Taipei (TW); Chin-Long Chen, Taipei (TW); Chien-An Chen Liu, Taipei (TW); Chien-Ten Chen, Taipei (TW); Shu-I Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/959,149

(22) Filed: Oct. 7, 2004

(51) Int. Cl. A23B 7/148

(52) U.S. Cl. 426/106

(57) ABSTRACT

Disclosed is preservation structure and preservation repository using the same. The preservation structure is constituted by a porous two-dimensional or three-dimensional solid structure with a slackness nature and a variety of nano-materials being uniformly distributed over the surface of the porous two-dimensional or three-dimensional solid structure, and is used to preserve an article therein over a long period of time. The freshness of the article is retained by making a direct contact between the nano-materials and the article. The usage of term or the period of preservation for the article is prolonged by placing the article needing to be preserved in the preservation repository.

### FIELD OF THE INVENTION

The present invention is related to a preservation structure and a preservation repository using the same, and more particularly to a preservation structure being molded by a nano-material and a preservation repository for prolonging the period of preservation for an article needing to be preserved.

### BACKGROUND OF THE INVENTION

In the contemporary era, almost all sorts of articles, including comestibles, cosmetics, cleaning and sanitary toolkits, and medicine, have a limited period of preservation. To prolong the period of preservation for those articles that can not be preserved permanently, normally they are added with a preservative or antiseptic, and are also packaged in a vacuum vessel or refrigerated in a freezer.

In consideration of food refrigeration, most of the families or grocery stores use a sealing can for food package or use a freezer in order to retain the freshness of foodstuff. However, the function of a sealing can is to isolate the air and moisture within the sealing can from conducting convection with outside only, while the air and moisture within the sealing can is not removable. Therefore, the foodstuff preserved in a sealing can is susceptible to corruption. Besides, the freezer only serves to preserve vegetables and fruit for a short-run period, and the conditioning air circulating within the freezer can result in a deficiency that the water content of the foodstuff is easily to be drained. In this manner, the effectiveness of food preservation by using a freezer will be degenerated. In addition, refrigeration can only be done with electricity, which limits the extent of feasibility and requires additional apparatus and cost for preservation.

Another improvement to dissolve the drawbacks experienced by a sealing can is brought by a vacuum sealing can. The principle of the vacuum sealing can is achieved by using a vacuum pump placed on the top surface of the sealing can to extract the air within the sealing can so as to lay a vacuity inside the sealing can. However, such vacuity can not absolutely ensure that the interior of the sealing can is out of air. Also it is not possible to be aware of the accident that the air enters into the sealing can through a puncture thereon, and thus the effectiveness of food preservation is limited.

Considering the preservation of cosmetics, cleaning and sanitary toolkits, and medicine, it is a usual situation that a preservative, antiseptic or desiccative is added into the airtight package in order to prolong the term of usage for these articles. However, once these articles are unpacked, the effectiveness of preservation will be discounted significantly. Even if these articles being doped with such additive is preserved in a sealing can or refrigerated in a freezer, the foregoing drawbacks can not be thoroughly eliminated, and yet the period of preservation for these articles can not be prolonged substantially.

In view of the problems confronted by the prior art, there is a need to contrive a preservation structure and a preservation repository to obviate the drawbacks persisting in the prior art.

### SUMMARY OF THE INVENTION

A first object of the present invention is accomplished by the provision of a preservation structure and a preservation repository that makes use of the fresh-keeping characteristics subjected to a nano-material to effectively prolong the usage of term or period of preservative for a liquidized, a fluid, a powdered, a grained, a syrupy, or a conglomerate article, without the need of using any antiseptic or desiccative.

Another object of the present invention is to provide a preservation structure and a preservation repository to retain the freshness of an article during a long-run preservation.

Another yet object of the present invention is to provide a preservation structure and preservation repository to guarantee an article to be preserved against damage and prevent the article from being dampened or spoiled.

To attain the foregoing objects, the preservation structure according to the present invention includes a porous two-dimensional or three-dimensional solid structure with a slackness nature, and a variety of nano-materials being uniformly distributed over the surface of the porous two-dimensional or three-dimensional solid structure, in such a way that the nano-materials can make a direct contact with the article to be preserved. The nano-materials can possess a different chemical composition with the porous two-dimensional or three-dimensional solid structure and are daubed on the surface of the porous two-dimensional or three-dimensional solid structure. Alternatively, the nano-materials can possess the same chemical composition with the porous two-dimensional or three-dimensional solid structure and are integrated with the porous two-dimensional or three-dimensional solid structure 14 by manufacturing a nano-structure to be attached to the surface of the porous two-dimensional or three-dimensional solid structure.

Besides, the preservation structure which is constituted by the porous two-dimensional or three-dimensional solid structure and the nano-materials can be placed in a container to form a preservation repository, wherein the internal chamber of the preservation repository can be used to preserve any article that requires a long-run preservation.

The foregoing and features and advantages of the present invention will become more apparent through the following descriptions with reference to the accompanying drawings, in which:

### BRIEF DESCRIPTION OF THE DRAWINGS

FIG. 1 is a schematic diagram showing the constitution of the preservation repository according to a preferred embodiment of the present invention;

FIG. 2 is a schematic diagram showing the constitution of the preservation repository according to another preferred embodiment of the present invention; and

FIG. 3 is a schematic diagram showing the constitution of the preservation structure according to a preferred embodiment of the present invention.

### DETAILED DESCRIPTION OF THE PREFERRED EMBODIMENT

The present invention allows the fresh-keeping characteristic of a nano-material to serve in a preservation repository for retaining the freshness of an article during a long-run preservation. Using the preservation repository pioneered by the present invention, the term of usage or the period of preservation for a liquidized, a fluid, a powdered, a grained, a syrupy, or a conglomerate article without the need of using an antiseptic or desiccative that would endanger the human health.

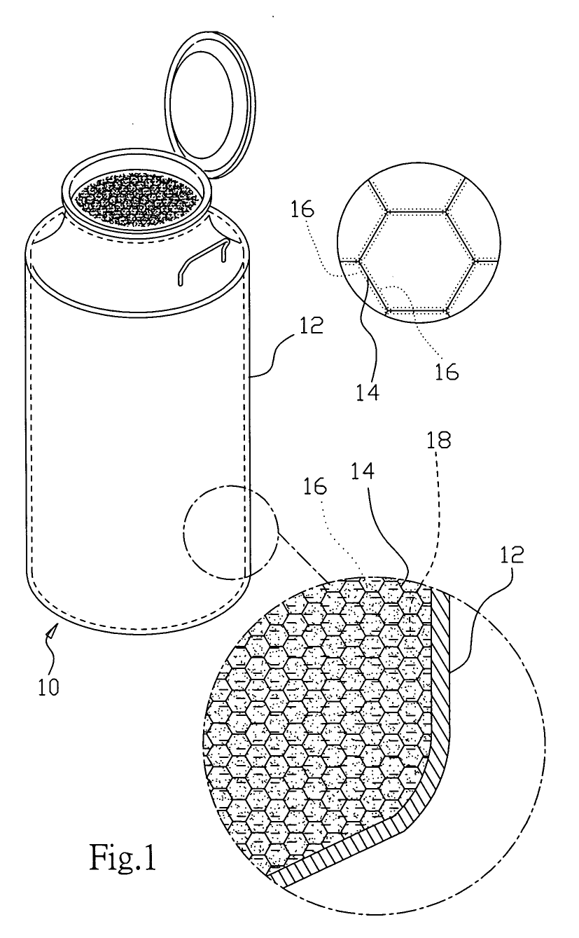

FIG. 1 is a schematic diagram showing the constitution of a preservation repository for preserving a large number of articles according to a preferred embodiment of the present invention. The preservation repository 10 includes a container 12 which can be a plastic container, a wooden container, a metal container, or a paper container, and is transparent or lucent so that an ultraviolet light with a wavelength being less than 410 nm can thoroughly or partly penetrate the container 12. A preservation structure constituted by a porous two-dimensional or three-dimensional solid structure 14 with a slackness nature and a variety of nano-materials 16 is mounted in the internal chamber of the container 12. The porous two-dimensional or three-dimensional solid structure 14 can be configured with a two-dimensional or three-dimensional meshed structure, a spongy structure, or a helix structure, so that the porous two-dimensional or three-dimensional solid structure 14 is filled up in the entire internal chamber of the container 12. The nano-materials 16 are formed by nano-particles, and are made up of material such as titanium oxide, zinc oxide, or gallium oxide, etc. that is provided with a photocatalytic effect. Also, the energy gap of the nano-materials 16 is set between 2.8 and 5 ev, and the nano-materials 16 are uniformly distributed over the surface of the porous two-dimensional or three-dimensional solid structure 14. When the articles 18 to be preserved are placed in the barrel vessel 12, each of the articles 15 has a direct contact with the nano-materials 16, so that the freshness of the articles 12 can be retained over a long period of time, and the period of preservation for the articles 18 can be prolonged.

In addition, the nano-materials 16 can possess a different chemical composition with the porous two-dimensional or three-dimensional solid structure 14, and are daubed on the surface of the porous two-dimensional or three-dimensional solid structure 14. Alternatively, the nano-materials 16 can possess the same chemical composition with the porous two-dimensional or three-dimensional solid structure 14, and are integrated with the porous two-dimensional or three-dimensional solid structure 14 by manufacturing a nano-structure to be attached to the surface of the porous two-dimensional or three-dimensional solid structure 14. The dimension of the nano-materials 16 is set between 1 and 200 nm.

The material used to constitute the porous two-dimensional or three-dimensional solid structure 14 can be selected from a group consisting of nylon fiber, nylon knitted fabric, nylon woven fabric, polyester fiber, polyester knitted fabric, polyester woven fabric, woolen fiber, non-woven fabric, and industrial fabric. The articles 18 to be preserved can be selected from a group consisting of comestibles, cosmetics, cleaning and sanitary toolkits, and medicine. The comestibles contain dairy produce, beverages, alimentary foods, assorted grains and crops, infant food, wine, edible oil, seasonings, and refreshment foods; the dairy produce contains cow's milk, goat milk, sour milk, yogurt, milk powder, cream cheese, and cheese powder; the beverage contain bottled beverage, canned beverage, cartoned beverage, brewage beverage, and blended beverage; the bottled beverage, canned beverage, cartoned beverage contain mineral water, fruit juice, vegetable juice, soda water, sarsaparilla, cola, soybean milk, rice and peanut milk, tea, sports drink, and coffee; the brewage beverage and the blended beverage contain green tea powder, coffee powder, tea bag, condensed juice, cocoa powder, and chocolate powder; the assorted grains and crops include rice, corn, wheat, oat, sesame, flour, cornmeal, wheatmeal, potato starch, Job's-tears powder, almond powder, and powder of the melange of assorted grains and crops; the alimentary foods contain chicken essence, glossy ganoderma, loquat jelly, fruit vinegar, and edible bird's nest; the infant food contains juice, fruit pulp, vegetable pulp, and flesh pulp; the wine contains alcoholic beverages including beer, vintage, and fruit wine; the edible oil contains soybean oil, sunflower oil, vegetable seed oil, corn oil, olive oil, grape seed oil, and peanut oil; the seasonings contain salt, sugar, soybean sauce, balsam, sesame oil, vinegar, ketchup, oyster oil, miso, monosodium glutamate, barbeque sauce, curry, and spice; the refreshment foods contain honey, fruit sugar, syrup, jam, peanut butter, chocolate sauce, salad sauce, fried pork flakes, dried shredded fish, savory flake, laver sauce, and instant soup; the cosmetics contain perfume, cosmetics lotion, cream, eye cream, facial film, lip balm, lipstick, facial milk lotion, body milk lotion, anti-wrinkle cream, pressed powder, mascara, make-up toiletries, cleaning lotion, make-up remover, clarifying milk, clarifying lotion, and hand cream; the cleaning and sanitary toolkits contain saline solution, cleaning solution for contact lens, rinsing solution for contact lens, and soaking solution for contact lens; the medicine contains oral Chinese medicine, oral western medicine, external medicinal liquid, external application, external ointment, and external medicinal powder.

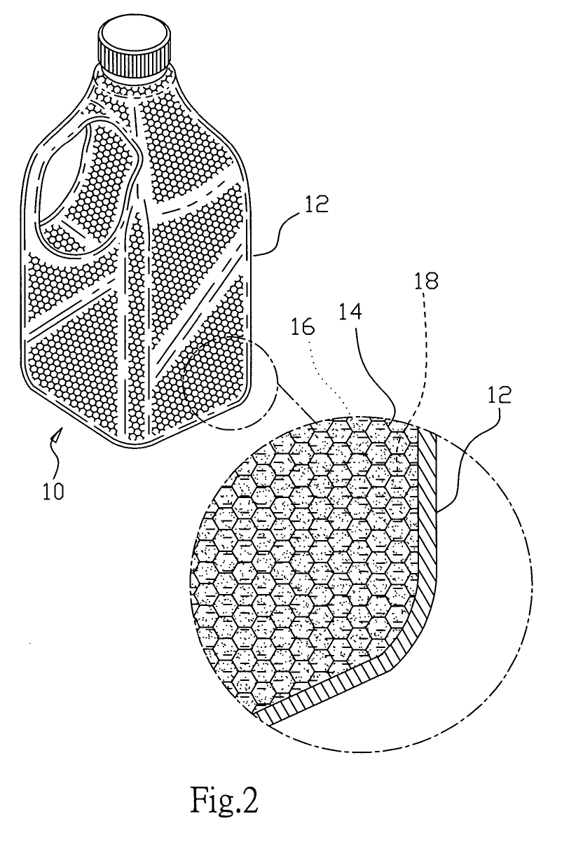

The configuration of the preservation repository 10 as shown in the preferred embodiment of FIG. 1 is embodied in a large-sized barrel vessel. However, the configuration of the preservation repository can be made in a wide variety of aspects; for example, the preservation repository can be modeled as a container used in a manufacturing/processing process or a container for storage. As shown in FIG. 2, the configuration of the preservation repository is modeled as a milk tank 12, and the article 18 to be preserved therein is milk. Meanwhile, the article (milk) 18 is in direct contact with the nano-materials 16, and thereby the period of preservation for the milk 18 can be prolonged. In particular, the freshness of milk 18 can be retained without being soured when the milk 18 is placed under room temperature.

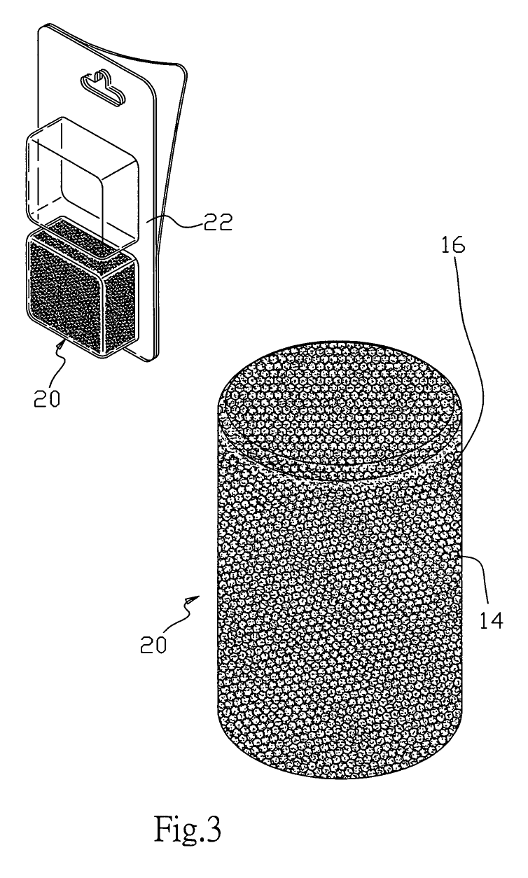

Furthermore, in order to facilitate the maneuverability of the preservation repository, as shown in FIG. 3 the preservation structure 20 which is constituted by the porous two-dimensional or three-dimensional solid structure 14 and nano-materials 16 can be packaged with an ordinary packing material in a compression type vacuum packing machine. Also, the dimension of the preservation structure 20 can be designed in a diversity of specifications, so that the consumer can choose a preservation structure with an appropriate dimension according to the size of the article to be preserved. When the consumer desires to use the preservation structure, the preservation structure can be inflated in an instant as long as the packaging material coated therewith is ripped off, so that the consumer can place the preservation structure in any kind of container; for example, a container suitable for holding water or alcohol, a thermos bottle, a thermos flask, a beverage bottle, or a beverage can.

To conclude, the preservation structure and the preservation repository according to the present invention can substantially prolong the period of preservation for articles, and guarantee the quality of articles. Thus, the articles needing to be preserved will not be damped or spoiled during a long-run preservation through the use of the present invention.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A preservation structure being mountable in a container for preserving an article placed in the container, the preservation structure comprising:
at least one porous two-dimensional or three-dimensional solid structure with a slackness nature; and
a plurality of nano-materials being attached to the surface of the porous two-dimensional or three-dimensional solid structure for making a direct contact with the article.

2. The preservation structure according to claim 1 wherein the porous two-dimensional or three-dimensional solid structure is configured with a two-dimensional or three-dimensional meshed structure, a spongy structure, or a helix structure.

3. The preservation structure according to claim 1 wherein a material used to constitute the porous two-dimensional or three-dimensional solid structure is selected from a group consisting of nylon fiber, nylon knitted fabric, nylon woven fabric, polyester fiber, polyester knitted fabric, polyester woven fabric, woolen fiber, non-woven fabric, and industrial fabric.

4. The preservation structure according to claim 1 wherein the nano-materials are provided with a photocatalytic effect.

5. The preservation structure according to claim 1 wherein the nano-materials are selected from a group consisting of titanium oxide, zinc oxide, and gallium oxide.

6. The preservation structure according to claim 1 wherein an energy gap of the nano-materials is set between 2.8 and 5 ev.

7. The preservation structure according to claim 1 wherein the article can be selected from a group consisting of comestibles, cosmetics, cleaning and sanitary toolkits, and medicine.

8. The preservation structure according to claim 7 wherein the comestibles contain dairy produce, beverages, alimentary foods, assorted grains and crops, infant food, wine, edible oil, seasonings, and refreshment foods.

9. The preservation structure according to claim 8 wherein the beverages contain bottled beverage, canned beverage, cartoned beverage, brewage beverage, and blended beverage.

10. The preservation structure according to claim 1 wherein the article is a liquidized, a fluid, a powdered, a grained, a syrupy, or a conglomerate article.

11. The preservation structure according to claim 1 wherein a configuration of the container is modeled as a container used in a manufacturing/processing process or a container for storage.

12. A preservation repository for receiving and preserving an article therein, comprising
a container with an internal chamber;
at least one porous two-dimensional or three-dimensional solid structure with a slackness nature being placed in the internal chamber and filled up with the internal chamber; and
a plurality of nano-materials being attached to the surface of the porous two-dimensional or three-dimensional solid structure for making a direct contact with the article.

13. The preservation repository according to claim 12 wherein the porous two-dimensional or three-dimensional solid structure is configured with a two-dimensional or three-dimensional meshed structure, a spongy structure, or a helix structure.

14. The preservation repository according to claim 12 wherein a material used to constitute the porous two-dimensional or three-dimensional solid structure is selected from a group consisting of nylon fiber, nylon knitted fabric, nylon woven fabric, polyester fiber, polyester knitted fabric, polyester woven fabric, woolen fiber, non-woven fabric, and industrial fabric.

15. The preservation repository according to claim 12 wherein the nano-materials are provided with a photocatalytic effect.

16. The preservation repository according to claim 12 wherein the nano-materials are selected from a group consisting of titanium oxide, zinc oxide, and gallium oxide.

17. The preservation repository according to claim 12 wherein an energy gap of the nano-materials is set between 2.8 and 5 ev.

18. The preservation repository according to claim 12 wherein the article can be selected from a group consisting of comestibles, cosmetics, cleaning and sanitary toolkits, and medicine.

19. The preservation repository according to claim 18 wherein the comestibles contain dairy produce, beverages, alimentary foods, assorted grains and crops, infant food, wine, edible oil, seasoning, and refreshment foods.

20. The preservation repository according to claim 19 wherein the beverages contain bottled beverage, canned beverage, cartoned beverage, brewage beverage, and blended beverage.

21. The preservation repository according to claim 12 wherein the article is a liquidized, a fluid, a powdered, a grained, a syrupy, or a conglomerate article.

22. The preservation repository according to claim 12 wherein the container is a plastic container, a wooden container, a metal container, or a paper container.

23. The preservation repository according to claim 12 wherein the container is allowed to be thoroughly or partly penetrated by an ultraviolet light with a wavelength being less than 410 nm.

24. The preservation repository according to claim 12 wherein the container is a transparent container or a lucent container.

25. The preservation repository according to claim 12 wherein a configuration of the container is modeled as a container used in a manufacturing/processing process or a container for storage.
